(19) United States
(12) Patent Application Publication
(10) Pub. No.: US 2005/0243172 A1
(43) Pub. Date: Nov. 3, 2005

(54) Rear view mirror with built-in camera

(76) Inventors: Teiichiro Takano, Tokyo (JP); Yoshifumi Kawaguchi, Tokyo (JP); Junji Nishiyama, Tokyo (JP); Takeaki Okamura, Tokyo (JP)

Correspondence Address: CERMAK & KENEALY, LLP, 515 EAST BRADDOCK RD SUITE B, Alexandria, VA, 22314, US

(21) Appl. No.: 11/114,183

(22) Filed: Apr. 26, 2005

(30) Foreign Application Priority Data
Apr. 30, 2004 (JP) 2004-135532
Jun. 23, 2004 (JP) 2004-185516

(51) Int. Cl. H04N 7/18

(52) U.S. Cl. 348/148; 348/143; 348/164

(57) ABSTRACT

A housing device, such as rear view mirror, with built-in camera can include an infrared projection device with an infrared light source for irradiating infrared light onto an image capture region for the camera. The camera can display a sensitivity to visible light and infrared light, and can be built into the mirror housing which is mounted to a vehicle and contains a mirror used for visual checking purposes. The infrared projection device can include a light transmission cover. The cover can be positioned in an infrared irradiation direction of the infrared light source, can be formed from a material that is impenetrable to visible light and transmits only infrared light, and can be attached to the mirror housing in an integral manner.

This application claims the priorities benefit under 35 U.S.C. § 119 of Japanese Patent Application Nos. 2004-135532 filed on Apr. 30, 2004 and 2004-185516 filed on Jun. 23, 2004, which are hereby incorporated by reference.

### BACKGROUND OF THE INVENTION

1. Field of the Invention

The invention relates to a rear view mirror with built-in camera, equipped with an infrared projection device. More specifically, the invention relates to a rear view mirror with built-in camera including a surveillance camera for monitoring the vicinity of the front wheel, and an infrared projection device that is capable of irradiating infrared light at the monitored region.

2. Description of the Related Art

It is well known that a blind spot exists near the front corners of vehicles, particularly in the vicinity of the front wheels. One known means for dealing with this blind spot involves attaching small CCD cameras to the housings of the door mirrors, enabling the sides near the front of the vehicle to be monitored.

If these attached CCD cameras protrude beyond the exterior of the door mirrors, then not only do they cause wind noise during operation of the vehicle, but they also tend to accumulate dirt. The wind noise can be disturbing to the driver, and the accumulated dirt causes a deterioration in the image quality from the camera within a comparatively short period of time.

In order to resolve these issues, a structure has been proposed in which a portion of the housing is formed from a transparent resin, and the entire CCD camera is then housed inside the housing, thereby canceling any wind noise, and preventing dirt accumulation.

This type of conventional rear view mirror 1 with built-in camera is shown in FIG. 6. In this configuration, a camera is built into a so-called door mirror 3 on the passenger side of the vehicle 2. This camera photographs a region A near the front wheel 2a on the passenger side of the vehicle, and the captured image is displayed on a display device (not shown in the figure) provided inside the vehicle. This configuration enables this obscured region to be safely checked from the driving seat.

In order to enable this type of rear view mirror with built-in camera to operate in dark environments, such as during the night or inside buildings, a camera is used that is sensitive to both visible and infrared light, and an infrared projection device comprising infrared LEDs or the like is provided. This infrared projection device irradiates infrared light at the image capture region photographed by the camera, enabling the CCD camera to capture a bright image.

This type of rear view mirror with built-in camera has already been reported in Japanese Patent Laid-Open Publications Nos. 2003-267140 and 2003-159998. The rear view mirrors with built-in cameras disclosed in these publications comprise a camera, and an infrared projection device formed from infrared LEDs housed inside a window provided in the rear surface of the rear view mirror casing. Infrared light is irradiated from the infrared projection device, through the window and onto a predetermined region. The resulting reflected light travels back through the window and is captured by the camera.

In the rear view mirror with built-in camera disclosed in Japanese Patent Laid-Open Publications No. 2003-267140, in order to prevent the infrared projection device from being visible through the window, a portion of a transparent cover that covers the window (the area of the window corresponding with the position of the infrared projection device) is formed using a material that is impenetrable to visible light and transmits only infrared light. The resulting housing is molded as a single integrated unit using a two-color molding technique.

As a result, if the window is viewed from an external position, then because visible light is unable to pass through the window, the infrared projection device provided inside the window cannot be seen, thus improving the exterior appearance. However, with this type of configuration, because a two-color molding technique must be used in the production of the transparent cover, the number of steps required to fabricate the transparent cover increases, causing an associated increase in production costs.

Furthermore, the rear view mirror with built-in camera disclosed in Japanese Patent Laid-Open Publications No. 2003-159998 simply refers to a transparent cover, and no particular attempt is made to prevent the projection device from being seen through the cover.

When a transparent cover is used, a method of blocking visibility of the infrared projection device by forming a multitude of lens cuts in the inside surface of the transparent cover is already known. However, in this type of structure, the shape of the transparent cover becomes very complex, increasing both the design costs and the cost of the mold.

Furthermore, in another conventional rear view mirror 1 with built-in camera shown in FIG. 7, the outside surface of the mirror housing 4 that faces the front of the vehicle slopes towards the rear as it extends from the side of the vehicle.

As shown in detail in FIG. 8, a plurality of infrared LEDs 5a that make up the infrared projection device 5, together with a substrate 5b, are aligned along the inside surface 4a of the mirror housing 4. In this case, the infrared light L emitted from the infrared projection device 5 is irradiated slightly away from the vehicle, into a region B that does not coincide with the image capture region A of the camera 6.

Providing lens cuts in the inside surface of the transparent cover is one possibility for ensuring that the infrared light L from the infrared projection device 5 can be directed towards the image capture region A of the camera 6. However, because lens cuts have already been formed in the transparent cover to prevent the infrared projection device 5 from being seen from an external position, providing extra lens cuts in the inner surface of the transparent cover to control the distribution of the infrared light is difficult.

As a result, conventionally, the plurality of infrared LEDs 5a within the infrared projection device 5 are mounted onto the substrate with the leads of each infrared LED 5a bent relative to the substrate 5b, as shown in FIG. 9. Alternatively, each infrared LED 5a is mounted on a separate substrate 5c, and these substrates 5c are then positioned in an inclined stepwise fashion, as shown in FIG. 10.

However, if the infrared LEDs 5a are mounted to the substrate 5b with the leads in a bent arrangement, as shown in the conventional example in FIG. 9, then bending each of the infrared LEDs 5a through a predetermined angle to the optimal orientation is difficult. This bending requires considerable time and cost during the assembly process, and increases the likelihood of variations in performance, meaning practical application of such a configuration is difficult.

Furthermore, if separate substrates 5c are used for each infrared LED, as in the conventional example of FIG. 10, then special substrates 5c must be designed and produced, which causes a reduction in production efficiency. Furthermore, positioning each of the individual substrates 5c with the optimal orientation is also difficult, which causes a substantial increase in cost.

Furthermore, if a light source mounted on a vehicle is to emit light outside the vehicle, then with the exception of the head lamps, the rear combination lamps, and the indicator or turn signal lamps, emission of visible light is undesirable. In other words, in the aforementioned conventional device equipped with an illuminating light source, the color and brightness of the light from the light source may cause problems. For example, red light leakage that occurs when infrared LEDs are used can be confused with tail lights or brake lights, which can cause problems of identification. Furthermore, even if other colors are used, then depending on the intensity of the light, the presence of an upward directed light beam near the passenger side door mirror may distract the drivers of oncoming vehicles.

### SUMMARY OF THE INVENTION

In accordance with an aspect of the invention, the above and other problems are taken into consideration to provide a rear view mirror with built-in camera that is equipped with an infrared projection device that has appropriate light distribution characteristics, and uses a simple structure to suppress the emission of visible light from the infrared projection device, thereby making the device substantially or totally invisible when viewed from an external position. This rear view mirror with built-in camera can enable the poor visibility blind spot near the front corner of a vehicle to be monitored using a CCD camera, causing little or no distractions for the drivers of oncoming vehicles. Furthermore, in accordance with another aspect of the invention, a rear view mirror with built-in camera can be provided in which the infrared projection device itself is of a simple construction.

According to another aspect of the invention, a rear view mirror with built-in camera can include an infrared projection device with an infrared light source for irradiating infrared light onto an image capture region for the camera, wherein the camera displays a sensitivity to visible light and infrared light, and is built into a mirror housing which is mounted to a vehicle and contains a mirror used for visual checking purposes. In this configuration, the infrared projection device can include a light transmission cover, which is positioned in an infrared irradiation direction of the infrared light source, and can be formed from a material that is substantially or totally impenetrable to visible light and transmits only infrared light, and can be attached to the mirror housing in an integrated manner.

In accordance with this aspect of the invention, infrared light emitted from the infrared light source of the infrared projection device passes through a transparent cover, and is irradiated onto the image capture region for the camera. The reflected infrared light from this image capture region enters the camera, enabling the camera to produce an image of the image capture region. Furthermore, the transparent cover can transmit the infrared light from the infrared light source of the infrared projection device, but may not transmit visible light. Consequently, if the transparent cover is viewed from an external position, the infrared light source of the infrared projection device positioned inside the transparent cover can be difficult to see or cannot be seen at all. This improves the aesthetic appearance of the infrared projection device, and can resolve the above problems associated with red light leakage.

When a transparent cover formed from a conventional transparent material is used, lens cuts can be formed in the inside surface of the transparent cover to prevent the infrared light source from being seen when viewed from an external position. However, in accordance with an aspect of the invention, this formation of lens cuts to prevent visibility may not be necessary, and the transparent cover can be formed in a simple manner.

In addition, because the transparent cover in this embodiment is provided only within the region facing the infrared light source of the infrared projection device, the type of two-color molding technique that has been necessary to form conventional integrated transparent covers is no longer necessary, meaning the transparent cover can be produced at a low cost, using a simple process.

In a rear view mirror with built-in camera made in accordance with another aspect of the invention, a light transmission spectrum of the material of the transparent cover intersects an emission spectrum of the infrared light source, which has been normalized relative to a peak intensity of the infrared light source, at a point on a long wavelength side of a peak wavelength of the infrared light source, and shows an increase from short wavelength bands to long wavelength bands.

In this aspect, the transmission spectrum of the transparent cover shows an increase from short wavelength bands to long wavelength bands and intersects the emission spectrum of the infrared light source of the infrared projection device at a longer wavelength than the peak wavelength of the infrared light source. Consequently, the transparent cover reliably transmits the infrared light from the infrared light source, while reliably blocking visible light and any small amount of red light leakage from the infrared light source. As a result, infrared light from the infrared light source of the infrared projection device passes through the transparent cover and is irradiated onto the predetermined region, while the infrared light source of the infrared projection device is reliably blocked from external view. Furthermore, any small amount of red light leakage from the infrared light source of the infrared projection device can be reliably blocked by the transparent cover. This removes potential distractions for nearby pedestrians or drivers of oncoming vehicles.

In another aspect of the invention, a rear view mirror with built-in camera can be configured such that the light transmission spectrum of the material of the transparent cover intersects the emission spectrum of the infrared light source, which has been normalized relative to the peak intensity, at a light transmittance value of 30 to 80%.

In this aspect of the invention, the transparent cover is able to transmit the infrared light from the infrared light source of the infrared projection device even more reliably, while still reliably blocking the transmission of visible light. As a result, infrared light from the infrared light source of the infrared projection device passes through the transparent cover and is irradiated onto the predetermined region, while the infrared light source of the infrared projection device is blocked even more reliably from external view.

If the light transmission spectrum of the material used for forming the transparent cover intersects with the infrared light source emission spectrum at a light transmittance of less than 30%, then the intensity of the infrared light passing through the transparent cover may fall significantly, making it substantially or totally impossible to achieve satisfactory illumination of the irradiation target region.

Furthermore, if the light transmission spectrum of the material used for forming the transparent cover intersects with the infrared light source emission spectrum at a light transmittance of more than 80%, then although the intensity of the infrared light passing through the transparent cover is adequate, small amounts of visible light are also transmitted, meaning the infrared projection device can be seen from an external position.

According to another aspect of the invention, a rear view mirror can include an infrared light source for an infrared projection device that can include an infrared LED that emits infrared light with a peak wavelength of no more than 900 nm, and preferably approximately 870 nm. The light transmission spectrum of the material of the transparent cover can intersect an emission spectrum of the infrared LED that has been normalized relative to a peak intensity, at a wavelength within a range from 850 to 900 nm, and preferably about 880 nm.

In this aspect of the invention, an infrared LED with a comparatively strong emission intensity at a peak wavelength of no more than 900 nm, and preferably approximately 870 nm, can be used, thereby enabling the infrared light from the infrared light source to be reliably transmitted, while visible light is reliably blocked.

A feature of this aspect is the use of an infrared light source that displays an emission spectrum with a comparatively broad half-width, such as an infrared LED, rather than a light source that displays an emission spectrum with a comparatively narrow half-width, such as an infrared laser diode (LD). As a result, the emission wavelengths extend into the visible region, causing a potential red light leakage problem. This red light leakage problem can be resolved by forming the transparent cover from a material that cuts the short wavelength light from the emission spectrum of the infrared LED.

Furthermore, as shown in FIG. 2, the camera sensitivity tends to fall with increasing wavelength within the infrared region. Accordingly, a light source for which the peak wavelength of the emission spectrum falls at a longer wavelength, although offering reduced red light leakage, suffers from lower camera sensitivity, meaning the captured image can become less distinct. As a result, it may be advantageous to use infrared LEDs for which the peak wavelength of the emission spectrum is no more than 900 nm.

In other words, by providing a transparent cover formed from a material that is capable of reliably cutting the emission of visible light, infrared LEDs with an emission spectrum peak wavelength of no more than 900 nm can be used. These LEDs can be configured to provide superior light emission efficiency and better camera sensitivity than infrared LEDs with emission spectrum peak wavelengths that fall at longer wavelengths. Thus, a brighter and more distinct captured image can be provided.

In addition, the light transmission spectrum of the material used for forming the transparent cover can have a leading edge at 850 nm or more, or can intersect with the light emission spectrum of the aforementioned infrared LEDs at a wavelength within a range from 850 to 900 nm. This enables visible light emitted from infrared LEDs with an emission spectrum peak wavelength of no more than 900 nm to be reliably blocked.

In those cases where infrared LEDs with an emission spectrum peak wavelength of 870 nm are used, the material used for forming the transparent cover preferably displays a light transmission spectrum that intersects with the light emission spectrum of the infrared LEDs at a wavelength of approximately 880 nm.

In a rear view mirror with built-in camera according to yet another aspect of the invention, the infrared light source can include a plurality of infrared LEDs mounted on a substrate. The plurality of infrared LEDs can be positioned in a matrix arrangement aligned along a vertical direction of the vehicle and/or a lengthwise direction of the housing, so that optical axes of the infrared LEDs are aligned substantially perpendicularly to the substrate. In addition to this, lens cuts can be formed in the transparent cover and each can include a plurality of divided prism cuts each having a different refraction angle across a horizontal direction of the vehicle corresponding to an irradiation region by a single infrared LED, and can convert light from the infrared LED to a substantially parallel light beam, thereby generating desirable light distribution characteristics.

In this aspect, the infrared light emitted from the infrared light source of the infrared projection device passes through the transparent cover, and is diffracted by the lens cuts formed in the inside surface of the transparent cover. This enables the light distribution characteristics to be controlled, and allows the light to be irradiated reliably onto the image capture region for the camera. As a result, reflected infrared light from this image capture region enters the camera, enabling the camera to produce an image of the image capture region.

In this construction, lens cuts for preventing the infrared light source from being seen from an external position have not been formed in the inside surface of the transparent cover. Consequently, the lens cuts described above, for controlling the light distribution, can be formed simply and at low cost.

Accordingly, even if the infrared light source of the infrared projection device is positioned along the inside surface of a mirror housing that slopes towards the rear as it extends from the side of the vehicle, each of the infrared LEDs can still simply be mounted on a single flat substrate. Conventional solutions such as bending the leads of the infrared LEDs of the infrared light source to ensure that each infrared LED is inclined along the desired direction of irradiation, or mounting each of the infrared LEDs on a separate substrate and then arranging these substrates in an inclined stepwise fashion may not be necessary. As a result, the infrared light from each of the infrared LEDs can be reliably oriented and distributed in the desired irradiation direction by the transparent cover lens cuts, meaning irradiation is conducted with a high level of efficiency.

In accordance with another aspect of the invention, a surface unevenness with a height difference of approximately ±0.01 mm can be provided in the transparent cover, at least within a section in which the lens cuts are formed.

The transparent cover can be formed from an infrared transmitting resin, which blocks visible light of no more than 840 nm, but transmits infrared light of longer wavelengths. The camera can be a CCD camera that also displays sensitivity to wavelengths of 840 nm or longer.

The transparent cover can be formed from an acrylic resin that has been colored a deep blue or deep green color, and can be effectively opaque to visible light.

The infrared LEDs can be driven by a pulse drive process that exceeds a rated current near a rated power of the LEDs.

According to still another aspect of the invention, a rear view mirror with built-in camera can include an infrared projection device with an infrared light source for irradiating infrared light onto an image capture region for the camera. The camera can display sensitivity to visible light and infrared light, and can be built into a mirror housing which is mounted to a vehicle and contains a mirror used for visual checking purposes. In this configuration, the infrared projection device can include a light transmission cover, which can be positioned in an infrared irradiation direction of the infrared light source, can be formed from a material that is impenetrable to visible light and transmits only infrared light, can be attached to the mirror housing in an integrated manner, and can include lens cuts formed in an inside surface thereof, for controlling light distribution characteristics of light from the infrared light source of the infrared projection device. Furthermore, a light transmission spectrum of the material of the transparent cover can intersect an emission spectrum of the infrared light source, which has been normalized relative to a peak intensity of the infrared light source, at a point on a long wavelength side of a peak wavelength of the infrared light source, and shows increase from short wavelength bands to long wavelength bands.

As described above, the infrared projection device can include a transparent cover that is positioned within the infrared direction of the infrared light, and can be formed from a material that is impenetrable to visible light and transmits only infrared light. Accordingly, when the transparent cover is viewed from an external position, the infrared light source of the infrared projection device positioned inside the transparent cover cannot be seen, meaning the aesthetic appearance of the infrared projection device is improved. Furthermore, this shielding of the infrared light source is unaffected by external light, and can be maintained whether or not the light source is emitting light.

In this case, there may be no need to form lens cuts in the inside surface of the transparent cover to prevent the infrared light source from being seen from an external position, as is sometimes required in devices that use transparent covers formed from conventional materials. Thus, formation of the transparent cover can be relatively simple.

In addition, by forming lens cuts in the inner surface of the transparent cover for the purpose of controlling the light distribution characteristics of the light from the infrared light source of the infrared projection device, infrared light emitted from the infrared light source of the infrared projection device passes through the transparent cover, and can be diffracted by lens cuts provided in the inside surface of the transparent cover. This enables the light distribution characteristics to be controlled, ensuring that the light is irradiated reliably onto the image capture region for the camera.

As a result, even if the infrared light source of the infrared projection device is positioned along the inside surface of a mirror housing that slopes towards the rear as it extends from the side of the vehicle, each of the infrared LEDs can still simply be mounted on a single flat substrate. Conventional solutions such as bending the leads of the infrared LEDs of the infrared light source to ensure that each infrared LED is inclined along the desired direction of irradiation, or mounting each of the infrared LEDs on a separate substrate and then arranging these substrates in an inclined stepwise fashion may not be required. Accordingly, during irradiation, the infrared light from each of the infrared LEDs can be oriented and distributed in the desired irradiation direction by the transparent cover lens cuts.

The rear view mirror with built-in camera can have a simple structure to prevent the infrared projection device from being seen from an external position, and the infrared projection device can also be of a simple construction.

In accordance with another aspect of the invention, a vehicle camera device can include a housing configured for mounting to a vehicle. A camera can be located adjacent the housing, the camera being sensitive to visible light and infrared light. An infrared light source can be located adjacent the housing and capable of irradiating infrared light in an infrared irradiation direction and towards an image capture region for the camera. A light transmission cover can be positioned in the infrared irradiation direction of the infrared light source and formed from a material that is substantially impenetrable to visible light and that transmits substantially only infrared light. At least one lens portion can be provided and configured to redirect the light emitted from the infrared irradiation direction into a second different direction.

### BRIEF DESCRIPTION OF THE DRAWINGS

These and other features and advantages of the invention will become clear from the following description with reference to the accompanying drawings, wherein:

FIG. 1 is a schematic plan view showing the structure of one embodiment of a rear view mirror with built-in camera made in accordance with the principles of the invention;

FIG. 2 is a graph showing the sensitivity characteristics for the camera in the rear view mirror with built-in camera shown in FIG. 1;

FIG. 3 is an enlarged plan view showing the structure of an infrared projection device in the rear view mirror with built-in camera shown in FIG. 1;

FIG. 4 is a graph showing the normalized emission spectrum for infrared LEDs, and the light transmission spectrum for a transparent cover in the rear view mirror with built-in camera shown in FIG. 1;

FIG. 5 is a graph showing the infrared LED emission spectrum from FIG. 4, together with the light transmission spectra for specific materials that can be used for the transparent/transmission cover;

FIG. 6 is a schematic plan view describing the use of a conventional rear view mirror with built-in camera;

FIG. 7 is a schematic plan view showing the structure of one example of a conventional rear view mirror with built-in camera;

FIG. 8 is an enlarged plan view showing the structure of an infrared projection device in the rear view mirror with built-in camera shown in FIG. 7;

FIG. 9 is a schematic plan view showing the structure of another example of a conventional rear view mirror with built-in camera;

FIG. 10 is a schematic plan view showing the structure of yet another example of a conventional rear view mirror with built-in camera;

FIG. 11 is a perspective view showing the structure of a light source for a rear view mirror with built-in camera made in accordance with the principles of the invention;

FIG. 12 is an explanatory diagram showing the combination of a light source and a transparent/transmission cover;

FIG. 13 is an explanatory diagram showing the positioning of lens cuts relative to infrared LEDs;

FIG. 14 is an explanatory diagram showing an effect of the lens cuts; and

FIG. 15 is a perspective diagram of another embodiment of a rear view mirror with built-in camera made in accordance with the principles of the invention.

### DETAILED DESCRIPTION OF PREFERRED EMBODIMENTS

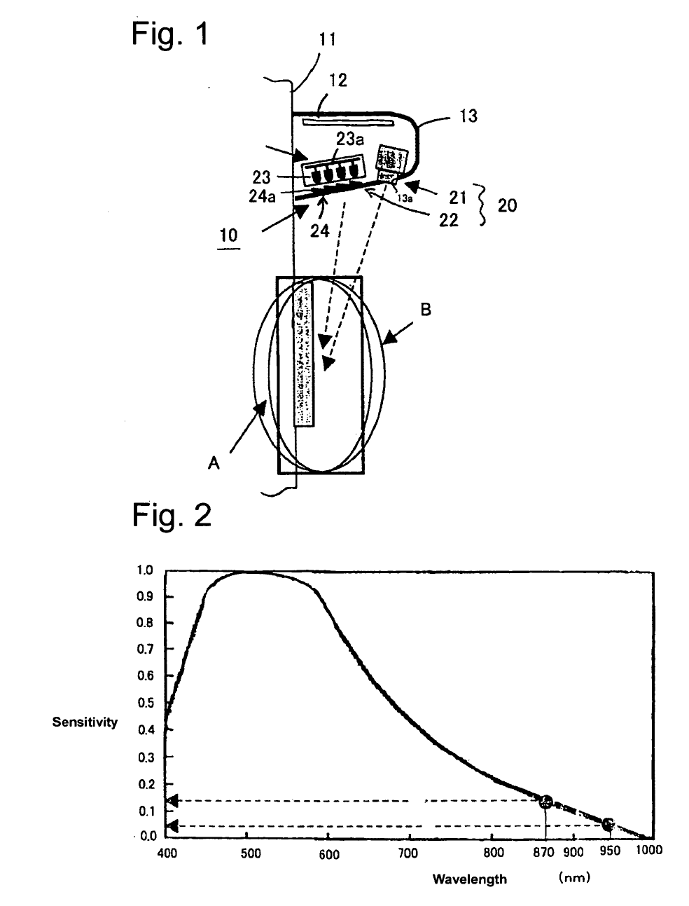

The following is a detailed description of various embodiments of the invention, with reference to FIG. 1 through FIG. 5. The embodiments described below represent specific examples of various forms of the invention, and therefore include a variety of technical features. The scope of the invention should not be considered to be limited to these embodiments.

FIG. 1 shows an embodiment of a rear view mirror with built-in camera made in accordance with the principles of the invention.

In FIG. 1, a rear view mirror 10 with built-in camera is a so-called door mirror that can be positioned, for example, on the left-hand passenger side of a vehicle 11. The rear view mirror 10 can include a mirror housing 13 that contains a mirror 12 for visually checking behind the vehicle, and a camera module 20 that is built into the lower region of the mirror housing 13. In this embodiment, the definitions of left and right are based on the direction of movement of the vehicle 11. Furthermore, the definitions of up and down are based on the vertical height direction of the vehicle 11 (the direction perpendicular to the ground on which the vehicle 11 is located).

The mirror housing 13 can be formed so as to open towards the rear, and the mirror 12 can be positioned across the rear end face of this opening. This mirror 12 can be positioned so that a driver sitting in the driving seat of the vehicle 11 is able to check the left rear of the vehicle 11 via this mirror 12. The viewing direction of the mirror 12 can be adjustable by driving the mirror up and down, or left and right, using a drive mechanism that is not shown in the figure.

The camera module 20 can include a camera 21, and an infrared projection device 22. The camera 21 can be an image capture device such as a CCD camera, and can be positioned facing forward and with a slight downward inclination, through a window 13a provided in the mirror housing 13.

The camera 21 can be capable of sensing both visible light and infrared light. Specifically, the camera 21 does not have to use an infrared cut filter and, as shown by the solid line in FIG. 2, can display a sensitivity from the visible region through to a wavelength of approximately 1000 nm in the infrared region (wherein, for example, the relative sensitivity to infrared light at a wavelength of 870 nm, relative to a peak sensitivity of 1.0, is 0.12).

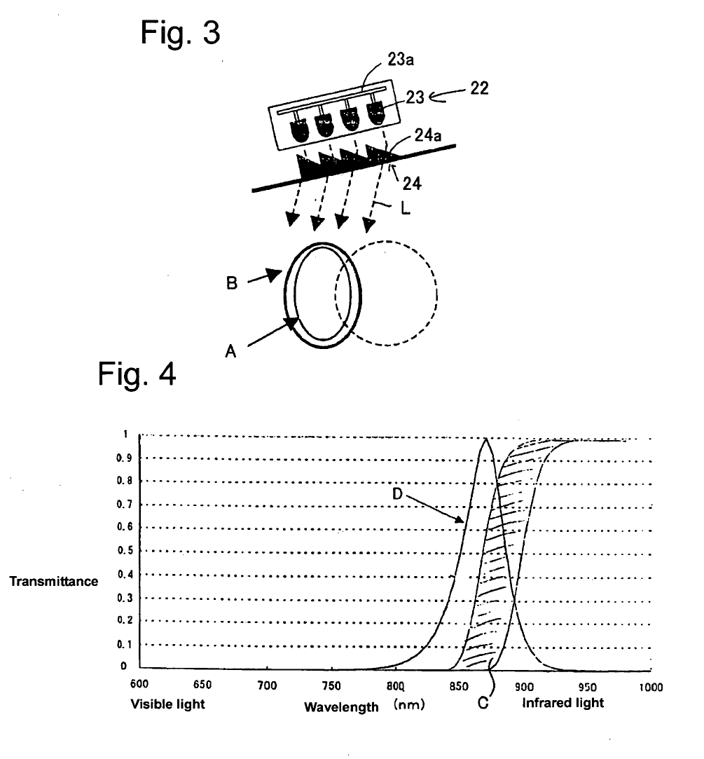

The infrared projection device 22 is a device for irradiating infrared light onto the image capture region for the camera 21, and can include infrared LEDs 23 that function as an infrared light source, and a transparent cover 24. The infrared LEDs 23 are, for example, LEDs that emit infrared light with a peak wavelength at 870 nm, and can be mounted in a straight line on a single flat substrate 23a, as shown in FIG. 3. The infrared LEDs 23 mounted on the substrate 23a can be aligned along the inside surface of the mirror housing 13.

Infrared LEDs with a peak wavelength at 950 nm are also commercially available, but their emission intensity is considerably lower than that of the 870 nm infrared LEDs, and they would also cause a lowering in the sensitivity of the camera 21. For these reasons, the present embodiment employs infrared LEDs with a peak wavelength at 870 nm in order to enable capture of a brighter image.

As shown in FIG. 1 and FIG. 3, the transparent/transmission cover 24 can be formed as an integral part of the housing 13, and in a position that covers the irradiation direction of the infrared light from the infrared LEDs 23. The transparent cover 24 can be formed as an integral part of the mirror housing 13 using a material that is impenetrable to visible light and that transmits only infrared light.

In addition, lens cuts 24a for controlling the light distribution of the infrared light emitted by the infrared LEDs 23 can be provided in the inside surface of the transparent cover 24. Specifically, as shown in FIG. 3, these lens cuts 24a can control the light distribution so that the infrared light emitted from each of the infrared LEDs 23 of the infrared projection device 22 is irradiated onto a region B that substantially coincides with the image capture region A of the camera 21.

By forming the lens cuts 24a in locations with a predetermined positional relationship relative to each of the infrared LEDs 23, the infrared light emitted from each of the infrared LEDs 23 can be efficiently irradiated onto the predetermined region B. A more detailed description of this process is provided below.

The transparent cover 24 can be formed from a material with the optical characteristics shown in FIG. 4. Namely, the light transmission spectrum C for the material can intersect the normalized emission spectrum D (an emission spectrum that has been normalized using a peak value of 1, hereafter simply referred to as the emission spectrum) for the infrared LEDs 23 that function as the infrared light source for the infrared projection device 22, at a point on the long wavelength side of the peak wavelength of the emission spectrum D. The light transmission spectrum C can also intersect at a light transmittance value of approximately 30 to 80% (the region indicated by diagonal lines in FIG. 4), while also showing increase from short wavelength bands to long wavelength bands.

If the light transmission spectrum for this material intersects the emission spectrum for the infrared LEDs 23 at a light transmittance of less than 30%, then the intensity of the infrared light transmitted through the transparent cover 24 can fall significantly, making it difficult to achieve satisfactory illumination of the irradiation target region. In contrast, if the light transmission spectrum for the material intersects the emission spectrum for the infrared LEDs 23 at a light transmittance exceeding 80%, then although the intensity of the infrared light transmitted through the transparent cover is adequate, small amounts of visible light may also be transmitted, making the infrared projection device visible from external positions.

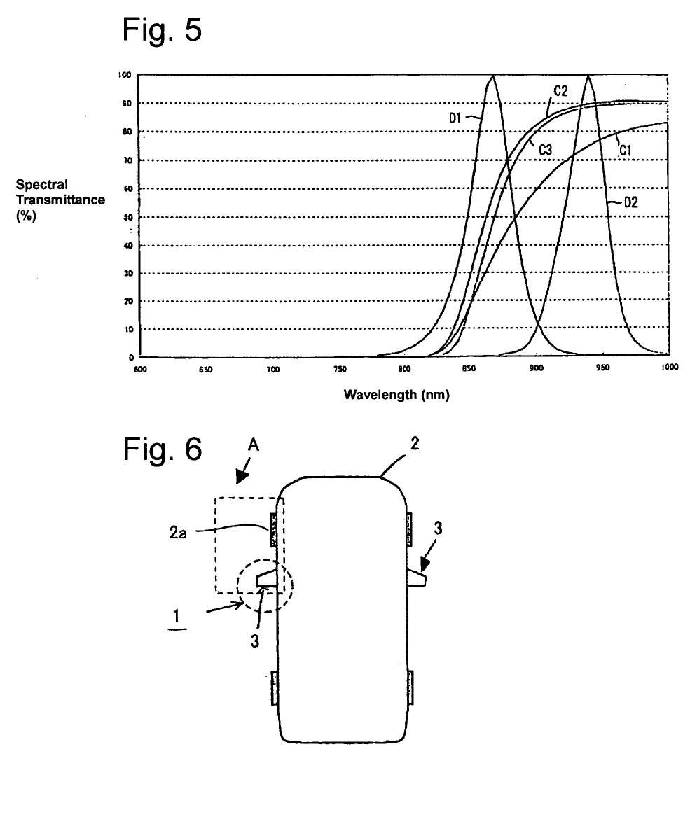

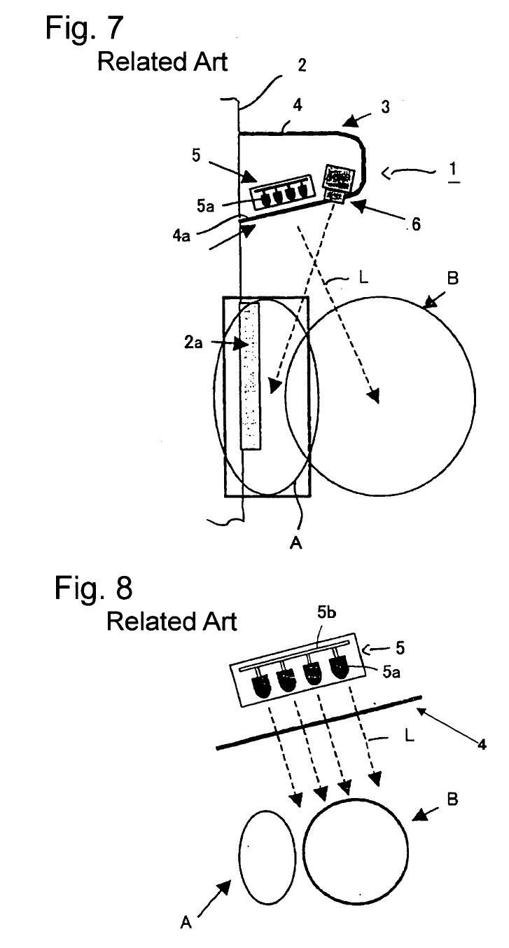

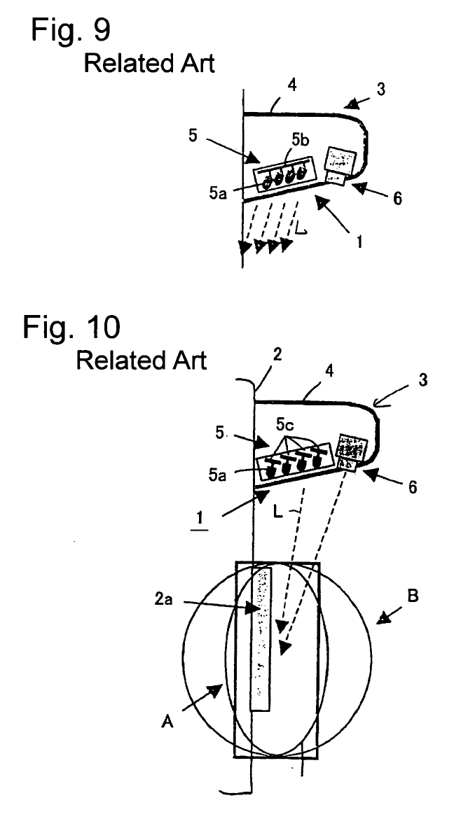

Specific examples of materials that can be used for the transparent cover 24 are shown in FIG. 5, and include a material A (the curve labeled C1), a material B (the curve labeled C2), and a material C (the curve labeled C3), all of which intersect the normalized emission spectrum D1 for the infrared LEDs with a peak wavelength of 870 nm at a light transmittance value between 30 and 80%.

In FIG. 5, a normalized emission spectrum D2 for an infrared LED with a peak wavelength of 950 nm is also shown for reference purposes.

In the rear view mirror 10 with built-in camera according to the embodiment of the invention described above, infrared light can be emitted from each of the infrared LEDs 23 of the infrared projection device 22 of the camera module 20 when the infrared LEDs 23 are operated via a drive circuit (not shown in the figures). The infrared light emitted from each of the infrared LEDs 23 can pass through the transparent cover 24 that can be an integral part of the mirror housing 13, and be irradiated onto a region B that substantially coincides with the image capture region A of the camera 21.

The reflected infrared light from this region B can then enter the camera 21, and the camera 21 can use this infrared light to produce an image of the image capture region A. An image signal from the camera 21 can then be displayed on a display screen or the like (not shown in the figures) provided inside the vehicle, enabling the driver to safely check the obscured or blind spot region near the passenger side front wheel, simply by viewing the infrared image of the image capture region A displayed on the display device.

In this case, because the infrared LEDs 23 of the infrared projection device 22 of the camera module 20 can be covered by the transparent cover 24, and because this transparent cover 24 can display a transmission spectrum that is related to the emission spectrum of the infrared LEDs 23 in the manner described above, any visible light (such as any small amount of red light leakage) can be reliably blocked during the transmission of the infrared light from the infrared LEDs 23.

According to the embodiment described above, the infrared LEDs 23 of the infrared projection device 22 can be invisible when viewed from an external position, thus improving the outward appearance of the infrared projection device 22, the camera module 20, and the rear view mirror 10 with built-in camera. Furthermore, in addition to this effect, red light leakage can be prevented, which can prevent distraction of nearby pedestrians or drivers of oncoming vehicles. In addition, this blocking of visible light can be unaffected by external light, and can be maintained whether or not the light source is emitting light. Furthermore, the transparent cover 24 does not require two-color molding technique, and can be formed at low cost, using a simple construction.

In addition, by providing the lens cuts 24a at the inside surface of the transparent cover 24, the distribution of the infrared light emitted from each of the infrared LEDs 23 of the infrared projection device 22 can be controlled by a corresponding lens cut 24a. As a result, efficient irradiation of infrared light onto the predetermined region B can be realized, thus enabling the capture of a bright and distinct image by the camera 21.

The above described embodiment does not require bending of the leads of each of the infrared LEDs 23, nor mounting of each of the infrared LEDs 23 on a separate substrate. Because all of the infrared LEDs 23 can be mounted on a single flat substrate, a simple, low-cost structure results, which also simplifies the installation within the mirror housing 13.

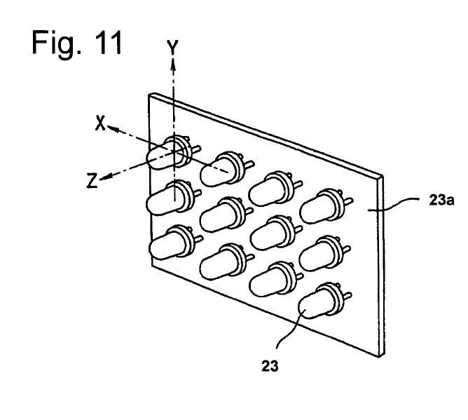

Next is a detailed description of infrared LEDs and lens cuts that can be used as shown in the embodiment of FIG. 11.

The lens cuts 24 can be configured to enable the light from the light source to be irradiated onto the region B, which substantially coincides with the image capture region A, even if the light source, which includes the plurality of infrared LEDs 23 with the optical axes Z aligned perpendicularly to the surface of the flat substrate 23a, is provided at an inclined angle relative to the vehicle 11.

In FIG. 11, a 3×4 matrix of infrared LEDs 23 is fitted to the surface of a substrate 23a (for example, a printed wiring board). Each row of LEDs can be aligned substantially parallel to the lengthwise direction (X) of the housing 13, or the lengthwise direction (X) of the substrate 23a. Each column of LEDs can be aligned basically parallel to the vertical direction of the vehicle body. The optical axis Z of each infrared LED 23 can be substantially perpendicular to the surface of the substrate 23a. This arrangement causes the light to be irradiated in a horizontal direction.

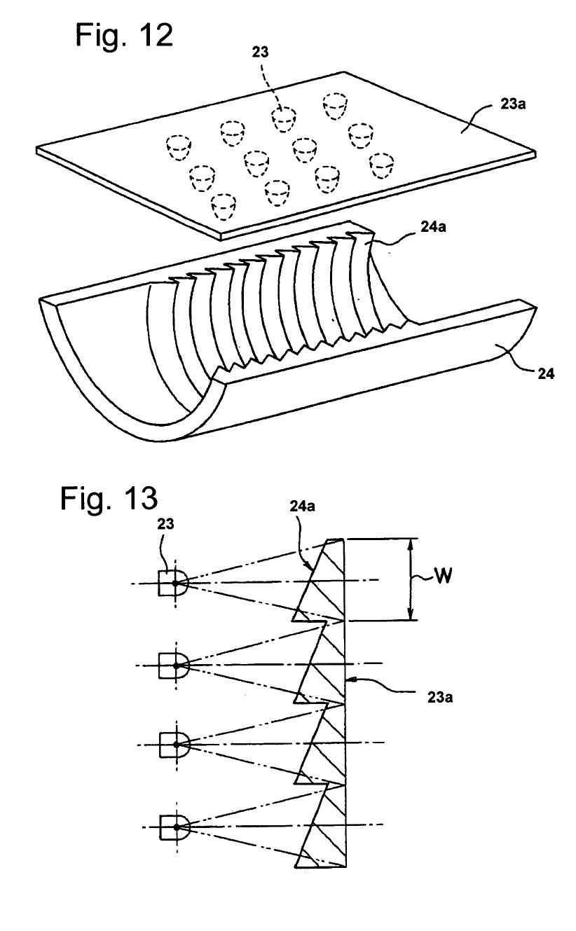

As shown in FIG. 12, lens cuts 24a can be formed in the inside surface of the transparent cover 24, corresponding with each column of the infrared LEDs 23. When the housing 13 that includes the transparent cover 24 is fitted to the vehicle 11, the columns of the infrared LEDs 23 can be aligned vertically relative to the vehicle, meaning the lens cuts 24a that correspond to these columns of infrared LEDs 23 can also be formed along the vertical direction relative to the vehicle 11. In a practical application, this portion of the transparent cover 24 may be curved, meaning the lens cuts 24a are divided within a plane that is parallel to the vertical direction of the vehicle 11 and perpendicular to the cover surface.

FIG. 13 shows a possible relationship between the infrared LEDs 23 and the lens cuts 24a. This figure represents a partial cross-sectional view in a substantially horizontal direction relative to the vehicle 11, and shows the transparent cover 24 and the infrared LEDs 23 (the substrate 23a and the like are omitted), as fitted to the vehicle 11.

Each of the lens cuts 24a can be provided to correspond with each infrared LEDs 23. For example, if four (rows of) infrared LEDs 23 are provided, then four (rows of) lens cuts 24a can also be provided.

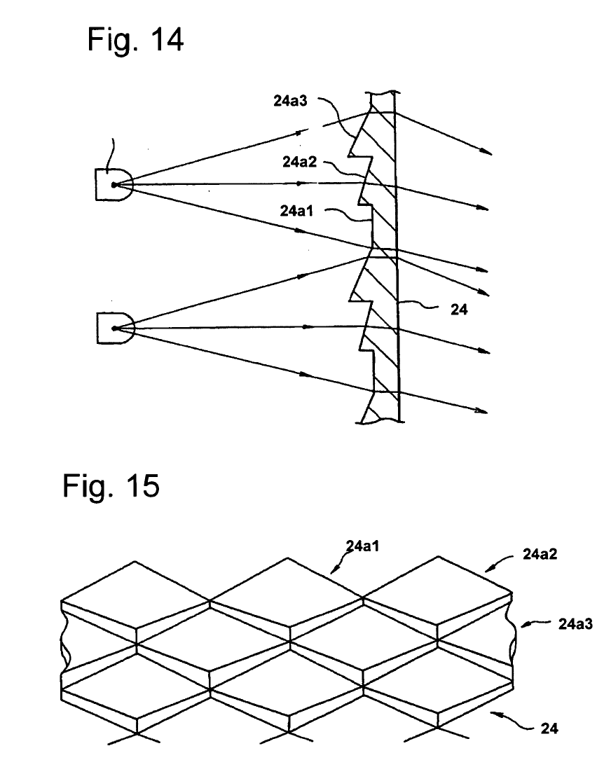

Each row of the lens cuts 24a can have a width that is determined by the radiation angle (the range over which the light is irradiated) of the infrared LEDs 23 and the distance between the LEDs 23 and the lens cuts 24a. If, as shown in FIG. 14, this width W is divided into an inside refraction section 24a1, a central refraction section 24a2, and an outside refraction section 24a3, then these refraction sections 24a1, 24a2, and 24a3 enable an appropriate light distribution to be generated from the light emitted by the infrared LEDs 23.

The actions and effects of the lens cuts 24a are described below in further detail, with reference to FIG. 14. Each infrared LED 23 can be selected soas to be able to irradiate a beam of light that forms a circular cone shape, which expands out at a radiation angle of 30° for example, from the infrared LED 23 positioned at the apex of the cone. Accordingly, the light from the infrared LED 23 can be diffused across an increasingly larger circle with increasing distance from the infrared LED 23.

The combination of the infrared LEDs 23 and the lens cuts 24a can be configured to enable the light from the LEDs 23 to be focused within a region near the front wheel of the vehicle, which is then monitored by the camera.

In the lens cuts 24a of the embodiment shown in FIG. 14, the inside refraction section 24a1 can be provided in the region that corresponds with the light path from the infrared LED 23 that is closest to the desired direction of irradiation. This inside refraction section 24a1 can include a prism cut that causes only weak refraction.

The central refraction section 24a2 can include a prism cut that causes a stronger refraction towards the desired irradiation direction than that imparted by the inside refraction section 24a1. Furthermore, the outside refraction section 24a3 can include a prism cut that causes an even stronger refraction towards the desired irradiation direction than that imparted by the central refraction section 24a2. This configuration ensures that almost all the light emitted from the infrared LEDs 23 is focused onto a region near the front wheel of the vehicle, namely the image capture region for the camera 21, thus enabling an efficient, high intensity illumination.

Furthermore, because the inside refraction section 24a1, the central refraction section 24a2, and the outside refraction section 24a3 can be formed along a direction perpendicular to the horizontal surface on which the vehicle 11 is sitting, the light emitted from each of these refraction sections 24a1 to 24a3 can be substantially parallel with the forward direction of the vehicle 11. Furthermore, the differences in the degree of refraction cause the beams of light from the different refraction sections to overlap. In other words, because the light is irradiated along a direction that is substantially parallel to the side of the vehicle, little or no portions of the monitored region are shaded, enabling a more accurate observation to be conducted.

In this embodiment, the description focused on a configuration in which the infrared LEDs 23 were arranged in a 3×4 matrix, and the lens cuts 24a were divided into the inside refraction section 24a1, the central refraction section 24a2, and the outside refraction section 24a3. However, the invention is not limited to this configuration. For example, the number of rows or columns of the infrared LEDs 23 may be either increased or decreased in accordance with various factors including the length and/or width of the transparent cover 24. Furthermore, the shape and number of different refraction sections within the lens cuts 24a may also be suitably adjusted.

In the above configuration, the infrared LEDs can be positioned in a matrix arrangement with the optical axes of the infrared LEDs perpendicular to the substrate, and the lens cuts can be provided in the transparent cover and can include a plurality of prism cuts that are divided across the direction of irradiation. This configuration enables the light from the infrared LEDs to be imparted with the desired light distribution characteristics, resulting in irradiation of a substantially parallel beam of light towards the front of the vehicle.

Furthermore, regardless of position within the matrix, each of the infrared LEDs can be fitted to the substrate with the optical axis aligned perpendicular to the substrate, meaning assembly does not require a special jig or gauge or the like, and can be completed simply by fitting each LED into a fitting hole provided in the substrate. Accordingly, production can be conducted using very common equipment such as a solder reflow oven, enabling simple cost reductions.

FIG. 15 shows another embodiment of a lens for a camera device made in accordance with the principles of the invention. In a vehicle 11 such as a truck, where the driving seat is in a raised position, the rear view mirror is typically also in a raised position. In this case, the amount of light from the LEDs that is diffracted downwards is limited, meaning the amount of light reaching the road surface near the front wheel target region tends to be insufficient.

In order to resolve this problem, in this embodiment, the three aforementioned linearly divided lens cuts (24a1, 24a2, 24a3) provided for each infrared LED 23 can be further divided in a substantially transverse direction, providing slopes that diffract the light in a specific direction (downwards for example).

Accordingly, light from the infrared LEDs 23 is not only diffracted along the side of the vehicle 11 in the manner described for the previous embodiment, but is also diffracted in a direction that is orthogonal to this sideways direction, namely downwards in this case. As a result, the road surface near the front wheel on the passenger side of the vehicle, for example, can be illuminated.

Next is a description of a member that can be used for forming the aforementioned lens cuts 24a. As described above, the infrared LEDs 23 can also emit visible light, depending on the chip structure and the size of the driving power.

The transparent cover 24 may be molded from an acrylic resin member that has been colored a deep blue or deep green color, for example, and this cover can be configured/constructed to transmit infrared light, but to prevent the transmission of visible light with a wavelength of less than approximately 840 nm.

Furthermore, by providing surface unevenness of approximately ±0.01 mm in either the lens cut surface of the acrylic resin member, or the outside surface of the cover, the apparent brightness of the light source can be reduced, and the irradiation of red light in a forward direction can be prevented. Based on investigations by the inventors of the invention, sandblasting the lens cut surface to provide a surface unevenness of approximately 0.01 to 0.05 mm, and preferably approximately 0.01 mm, enables more uniform light distribution characteristics to be achieved within the image capture region, when compared with the case in which the lens cuts have not been sandblasted. This results in a more effective illumination, and enables the capture of a higher quality image.

There are no particular restrictions on the method used for driving the infrared light source 23. However, if the phosphor of the monitoring device (not shown in the figures) used for monitoring the image from the camera 21 uses a material that possesses a suitable level of afterglow, then a continuous display can be provided on the monitoring device regardless of whether the infrared LEDs 23 emit light intermittently or continuously.

For example, if a pulsed lighting sequence is used in which the infrared LEDs 23 are lit for 0.02 seconds and then turned off for 0.1 seconds, then an approximately 5-fold current can be applied to the infrared LEDs 23 without exceeding the rated power level, meaning the brightness can also be increased approximately 5-fold. As a result, the brightness with which the target region is illuminated can be increased, while the afterglow of the phosphor and the visual afterimage enable monitoring to be conducted in a seemingly continuous manner.

The above description applies mainly to observation at night because, during the day, normal vision enables direct confirmation of the target region, and the above type of monitoring device may not be necessary. Furthermore, natural light also provides better illumination intensity and superior uniformity to the artificial light described above, meaning the image from the CCD camera is well defined, and ideal for conducting monitoring.

While there has been described what are at present considered to be preferred embodiments of the invention, it will be understood that various modifications may be made thereto, and it is intended that the appended claims cover all such modifications as fall within the true spirit and scope of the invention.

1. A rear view mirror with built-in camera, comprising:
a mirror housing configured for mounting to a vehicle and including a mirror for visual checking purposes;
an infrared projection device located adjacent the mirror housing and including an infrared light source for irradiating infrared light in an infrared irradiation direction and onto an image capture region for the camera, the camera being capable of sensing visible light and infrared light and located adjacent the mirror housing; and
a light transmission cover positioned in the infrared irradiation direction of the infrared light source and being formed from a material that is substantially impenetrable to visible light and that transmits substantially only infrared light, and being attached to the mirror housing in an integral manner.

2. The rear view mirror with built-in camera according to claim 1, wherein
the material of the transmission cover has a light transmission spectrum that intersects an emission spectrum of the infrared light source, which has been normalized relative to a peak intensity of the infrared light source, at a point on a long wavelength side of a peak wavelength of the infrared light source, and shows an increase from short wavelength bands to long wavelength bands.

3. The rear view mirror with built-in camera according to claim 2, wherein
the light transmission spectrum of the material of the transmission cover intersects the emission spectrum of the infrared light source, which has been normalized relative to the peak intensity, at a light transmittance value of 30 to 80%.

4. The rear view mirror with built-in camera according to claim 2, wherein
the infrared light source of the infrared projection device includes an infrared LED that emits infrared light with a peak wavelength of no more than 900 nm, and the light transmission spectrum of the material of the transmission cover intersects an emission spectrum of the infrared LED that has been normalized relative to a peak intensity, at a wavelength within a range from 850 to 900 nm.

5. The rear view mirror with built-in camera according to claim 2, wherein
the infrared light source of the infrared projection device includes an infrared LED that emits infrared light with a peak wavelength of 870 nm, and the light transmission spectrum of the material of the transmission cover intersects an emission spectrum of the infrared LED that has been normalized relative to a peak intensity, at a wavelength of about 880 nm.

6. The rear view mirror with built-in camera according to claim 1, wherein:
the infrared light source includes a plurality of infrared LEDs mounted on a substrate, the plurality of infrared LEDs being positioned in a matrix arrangement aligned along one of a vertical direction of the vehicle and a lengthwise direction of the housing, so that optical axes of the infrared LEDs are aligned substantially perpendicularly to the substrate; and
lens cuts are formed in the transmission cover and each includes a plurality of divided prism cuts having different refraction angles across a horizontal direction of the vehicle corresponding to an irradiation region for a single infrared LED, and converts light from the infrared LED to a substantially parallel light beam, thereby generating desirable light distribution characteristics.

7. The rear view mirror with built-in camera according to claim 6, wherein
a surface unevenness with a height difference of approximately ±0.01 mm is provided in the transmission cover, at least within a section in which the lens cuts are formed.

8. The rear view mirror with built-in camera according to claim 1, wherein
the transmission cover is formed from an infrared transmitting resin, which blocks visible light of no more than 840 nm, but transmits infrared light of longer wavelengths, and
the camera is a CCD camera that is capable of sensing wavelengths of 840 nm or longer.

9. The rear view mirror with built-in camera according to claim 1, wherein
the transmission cover is formed from an acrylic resin that has been colored a deep blue or deep green color, and is effectively opaque to visible light.

10. The rear view mirror with built-in camera according to claim 1, wherein
the infrared LEDs are driven by a pulse drive process that exceeds a rated current near a rated power of the LEDs.

11. A rear view mirror with built-in camera, comprising:
a mirror housing which is configured for mounting to a vehicle and contains a mirror used for visual checking purposes; and
an infrared projection device with an infrared light source for irradiating infrared light onto an image capture region for the camera which is capable of sensing visible light and infrared light and is built into the mirror housing, wherein the infrared projection device includes,
a light transmission cover, which is positioned in an infrared irradiation direction of the infrared light source, is formed from a material that is substantially impenetrable to visible light and transmits substantially only infrared light, is attached to the mirror housing in an integrated manner, and includes lens cuts formed at an inside surface thereof, for controlling light distribution characteristics of light from the infrared light source of the infrared projection device, and
a light transmission spectrum of the material of the transmission cover intersects an emission spectrum of the infrared light source, which has been normalized relative to a peak intensity of the infrared light source, at a point on a long wavelength side of a peak wavelength of the infrared light source, and increases from short wavelength bands to long wavelength bands.

12. The rear view mirror with built-in camera according to claim 3, wherein
the infrared light source of the infrared projection device includes an infrared LED that emits infrared light with a peak wavelength of no more than 900 nm, and the light transmission spectrum of the material of the transmission cover intersects an emission spectrum of the infrared LED that has been normalized relative to a peak intensity, at a wavelength within a range from 850 to 900 nm.

13. The rear view mirror with built-in camera according to claim 3, wherein
the infrared light source of the infrared projection device includes an infrared LED that emits infrared light with a peak wavelength of 870 μm, and the light transmission spectrum of the material of the transmission cover intersects an emission spectrum of the infrared LED that has been normalized relative to a peak intensity, at a wavelength of about 880 nm.

14. The rear view mirror with built-in camera according to claim 2, wherein:
the infrared light source includes a plurality of infrared LEDs mounted on a substrate, the plurality of infrared LEDs being positioned in a matrix arrangement aligned along one of a vertical direction of the vehicle and a lengthwise direction of the housing, so that optical axes of the infrared LEDs are aligned substantially perpendicularly to the substrate; and
lens cuts are formed in the transmission cover and each includes a plurality of divided prism cuts having different refraction angles across a horizontal direction of the vehicle corresponding to an irradiation region for a single infrared LED, and converts light from the infrared LED to a substantially parallel light beam, thereby generating desirable light distribution characteristics.

15. The rear view mirror with built-in camera according to claim 2, wherein
the transmission cover is formed from an infrared transmitting resin, which blocks visible light of no more than 840 nm, but transmits infrared light of longer wavelengths, and
the camera is a CCD camera that is capable of sensing wavelengths of 840 nm or longer.

16. The rear view mirror with built-in camera according to claim 6, wherein
the transmission cover is formed from an infrared transmitting resin, which blocks visible light of no more than 840 nm, but transmits infrared light of longer wavelengths, and
the camera is a CCD camera that is capable of sensing wavelengths of 840 nm or longer.

17. The rear view mirror with built-in camera according to claim 2, wherein
the transmission cover is formed from an acrylic resin that has been colored a deep blue or deep green color, and is effectively opaque to visible light.

18. The rear view mirror with built-in camera according to claim 6, wherein
the transmission cover is formed from an acrylic resin that has been colored a deep blue or deep green color, and is effectively opaque to visible light.

19. A vehicle camera device, comprising:
a housing configured for mounting to a vehicle;
a camera located adjacent the housing, the camera being sensitive to visible light and infrared light;
an infrared light source located adjacent the housing and capable of irradiating infrared light in an infrared irradiation direction and towards an image capture region for the camera;
a light transmission cover positioned in the infrared irradiation direction of the infrared light source and being formed from a material that is substantially impenetrable to visible light and that transmits substantially only infrared light, and including at least one lens portion configured to redirect the light emitted from the infrared irradiation direction into a second different direction.

20. The vehicle camera device of claim 19, wherein the housing is a mirror housing and the light transmission cover and lens portion are integral with the housing.
